(19) United States
(12) Patent Application Publication
(10) Pub. No.: US 2002/0166043 A1
(43) Pub. Date: Nov. 7, 2002

(54) Formatting optical disks

(75) Inventor: Richard C. Panico, Medford, MA (US)

Correspondence Address: HALE AND DORR, LLP, 60 STATE STREET, BOSTON, MA, 02109

(73) Assignee: Xenon Corporation

(21) Appl. No.: 10/105,797

(22) Filed: Mar. 25, 2002

Related U.S. Application Data
(60) Provisional application No. 60/278,774, filed on Mar. 26, 2001.

(51) Int. Cl. G06F 9/00; G06F 9/24; G06F 15/177

(52) U.S. Cl. 713/1

(57) ABSTRACT

An optical disk is initialized using a flash lamp with a short duration pulse and/or at close distance.

### CROSS REFERENCE TO RELATED APPLICATION

This application claims priority from application Ser. No. 60/278,774, filed Mar. 26, 2001, which is incorporated herein by reference.

### BACKGROUND OF THE INVENTION

Phase change optical memory disks, such as DVDs, can store information as microscopic patterns of high and low reflectivity, with the reflectivity related to a physical state of an active layer. An active material in a phase change optical memory disk may be deposited as an amorphous film. This film must be changed to a crystalline state as part of the manufacturing process. This changing process is referred to as “initializing.” The initializing process is typically performed with laser based initializers that are both slow and costly. The current method of formatting DVDs using lasers is slow, costly, and technically inadequate.

Energy exposure from a xenon flash lamp is generally known to crystallize a phase change alloy, as indicated in U.S. Pat. No. 5,684,778, which is expressly incorporated herein by reference. However, initializing with a flash lamp has not been used successfully in a manufacturing process. When large areas of material are crystallized simultaneously, stresses associated with the process can damage the disk.

### SUMMARY OF THE INVENTION

The invention includes systems and methods for using a flash lamp to provide a short duration pulse (less than 1,000 microseconds) to initialize an optical disk. The optical disk is preferably exposed as a whole to the pulse lamp. The energy is preferably provided with lower power from a shorter distance, such as less than 1 inch. The proximity from the lamp to the disk makes the surface temperature rapidly rise then fall rapidly, thereby preventing surface damage. Other features and advantages will become apparent from the following detailed description, drawings, and claims.

### BRIEF DESCRIPTION OF THE DRAWINGS

FIG. 1 is a block diagram of a system for initializing an optical disk.

### DETAILED DESCRIPTION

A process has been developed whereby an entire surface of an optical disk is exposed with a flash lamp without causing process damage and with an added benefit of noise reduction. The time for processing can be about 1 to 3 seconds, as compared to known laser methods which take more than 20 seconds. Furthermore, a laser has a shorter life than a flash lamp.

The method of the present invention was performed with a standard and known RC-742 pulse lamp system of the type sold by Xenon Corporation (located in Woburn, Mass.). Exemplary ranges of operating parameters include:

Pulse duration: 1 to 1,000 microseconds measured at ⅓rd peak value

Energy per pulse: 1 to 2,000 joules

Radiated time: 0.1 to 10 seconds

Distance from substrate: less than 1″

Lamp configuration (shape): linear or spiral

Lamp type: Quartz, Suprasil, or Sapphire

Spectrum: 100 to 1,000 nanometers

Lamp Cooling: ambient, forced air, or water

Wavelength selection outside the lamp: none or IR filter

Lamp housing window: Quartz, suprasil, or saffire

Unlike some other proposed techniques with a flash lamp, this method preferably uses a short duration pulse (less than 1000 microseconds), and is performed with lower power from a shorter distance than prior proposed methods that tend to use higher power over a greater distance. The close proximity advantageously makes the surface temperature rapidly rise, then fall rapidly, thereby preventing surface damage. The temperature drops rapidly between pulses. These differences (or at least some subset of these differences) enable the processing rapidly without the damage and with good noise qualities. It is further believed that the magnetic field from the flash lamp may be beneficial to the initializing process. Thus the power is sufficient to effect the phase change from about 1 inch or less without damaging the disk.

The method can be used with conventional DVDs, and is not limited to any particular type of adhesive or DVD substrate. The methods thus assist in the high speed manufacture of DVDs.

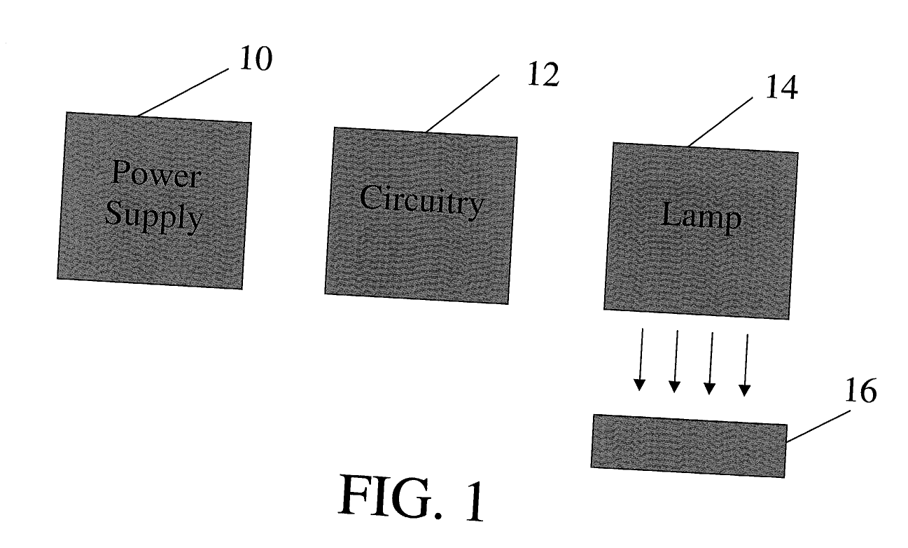

Referring to FIG. 1, the apparatus that can be used can be conventional flash lamp hardware, such as that provided by Xenon Corporation. Such devices typically include a power supply 10, circuitry 12 for providing short duration pulses, and a lamp 14 which may include xenon gas. As indicated above, the lamp can be one of several types, and the shape of the lamp can be a conventional linear shape or shaped in a spiral. The lamp would generally reside in a housing and provide a pulse of light to an optical disk 16 through a window that may filter some wavelengths of light. The pulse lamp system would also conventionally include a cooling mechanism such as fans, or the device could be air cooled.

Having described an embodiment of the present invention, it should be apparent that modifications can be made without departing from the scope of the claims. For example, as indicated above, a range of parameters, materials, distances, powers, window materials, use of a filter, and use of a heating plate beneath the disc or other supplemental heating or cooling are all further possibilities.

What is claimed is:

1. A method for initializing an optical disk including directing to the disk a pulse from a flash lamp with a duration of less than 1,000 microseconds.

2. The method of claim 1, wherein the lamp is spaced from the optical disk by 1 inch or less.

3. The method of claim 2, wherein the power is sufficient to initialize the disk without damaging the disk.

4. The method of claim 1, wherein the lamp is shaped in one of a linear or spiral configuration, and the lamp is made of one of quartz or sapphire.

5. The method of claim 1, wherein multiple pulses are provided over a time between 0.1 and 10 seconds.

6. The method of claim 1, wherein an entire optical disk is exposed to the flash lamp at the same time.

7. A method for initializing an optical disk including directing a pulse from a flash lamp spaced from the optical disk by 1 inch or less.

8. The method of claim 7, wherein the lamp is shaped in one of a linear or spiral configuration, and the lamp is made of one of quartz or sapphire.

9. The method of claim 7, wherein multiple pulses are provided over a time between 0.1 and 10 seconds.

10. The method of claim 7, wherein an entire optical disk is exposed to the flash lamp at the same time.
